(19) United States
(12) Patent Application Publication
(10) Pub. No.: US 2004/0161578 A1
(43) Pub. Date: Aug. 19, 2004

(54) Dual-layer protective overcoat system for disk recording media

(75) Inventors: Kueir-Weei Chour, San Jose, CA (US); Weilu Xu, San Jose, CA (US); Yao-Tzung Shih, Cupertino, CA (US); Kuo-Hsing Hwang, San Jose, CA (US); Chung Shih, Cupertino, CA (US)

Correspondence Address: MCDERMOTT, WILL & EMERY, 600 13th Street, N.W., Washington, DC, 20005-3096, US

(73) Assignee: Seagate Technology LLC

(21) Appl. No.: 10/367,754

(22) Filed: Feb. 19, 2003

(51) Int. Cl. B32B 3/02; G11B 7/24; G11B 5/72

(52) U.S. Cl. 428/65.4; 428/695; 427/162; 430/270.11

(57) ABSTRACT

A method of forming a dual-layer protective overcoat system on a surface of a workpiece, the protective overcoat system being abrasion and corrosion resistant and bondable to a lubricant topcoat, comprising sequential steps of:

(a) providing a workpiece including a surface;

(b) forming a first, bulk layer of a carbon (C) and hydrogen (H)-containing material on the surface of said workpiece, the bulk layer having a rough and porous upper surface; and

(c) forming a second, flash layer of a carbon (C) and nitrogen (N)-containing material on the surface of the bulk layer. Embodiments include forming disk-type magnetic and/or magneto-optical (MO) recording media comprising the dual-layer protective overcoat system and a lubricant topcoat layer.

### FIELD OF THE INVENTION

The present invention relates to an improved dual-layer protective overcoat system, a method of forming the dual-layer protective overcoat system, and to recording media comprising the improved dual-layer protective overcoat system. The invention enjoys particular utility in the manufacture of magnetic and/or magneto-optical (MO) recording media in the form of hard disks.

### BACKGROUND OF THE INVENTION

A magnetic recording medium, e.g., a hard disk, typically comprises a laminate of several layers, including a non-magnetic substrate, such as a disk of a aluminum-magnesium (Al-Mg) alloy or a glass, ceramic, or glass-ceramic composite material, and sequentially formed on at least one side thereof: a polycrystalline underlayer, typically of chromium (Cr) or Cr-based alloy, a polycrystalline magnetic recording medium layer, e.g., of a cobalt (Co)-based alloy, a hard abrasion-resistant, protective overcoat layer, typically carbon (C)-based, and a lubricant topcoat layer. Magneto-optical (MO) media, e.g., in disk form, similarly comprise a laminate of several layers, including reflective, dielectric, thermo-magnetic, protective overcoat, and lubricant topcoat layers.

In operation of e.g., the magnetic recording medium, the polycrystalline magnetic recording layer is locally magnetized by a write transducer, or write head, to record and store information. The write transducer creates a highly concentrated magnetic field which alternates direction based upon the bits of information being stored. When the local magnetic field produced by the write transducer is greater than the coercivity of the recording medium, then the grains of the polycrystalline recording medium at that location are magnetized. The grains retain their magnetization after the magnetic field produced by the write transducer is removed. The direction of magnetization matches the direction of the applied magnetic field. The magnetization of the polycrystalline recording medium can subsequently produce an electrical response in a read transducer, allowing the stored information to be read.

Thin film magnetic and MO recording media are conventionally employed in disk form for use with disk drives for storing large amounts of data in magnetizable form. Typically, one or more disks are rotated on a central axis in combination with data transducer heads. In operation, a typical contact start/stop (CSS) method commences when the head begins to slide against the surface of the disk as the disk begins to rotate. Upon reaching a predetermined high rotational speed, the head floats in air at a predetermined distance above the surface of the disk due to dynamic pressure effects caused by air flow generated between the sliding surface of the head and the disk. During reading and recording operations, the transducer head is maintained at a controlled distance from the recording surface, supported on a bearing of air as the disk rotates, such that the head can be freely moved in both the circumferential and radial directions, thereby allowing data to be recorded on and retrieved from the disk at a desired position. Upon terminating operation of the disk drive, the rotational speed of the disk decreases and the head again begins to slide against the surface of the disk and eventually stops in contact with and pressing against the disk. Thus, the transducer head contacts the recording surface whenever the disk is stationary, accelerated from the static position, and during deceleration just prior to completely stopping. Each time the head and disk assembly is driven, the sliding surface of the head repeats the cyclic sequence consisting of stopping, sliding against the surface of the disk, floating in the air, sliding against the surface of the disk, and stopping.

As a consequence of the above-described cyclic CSS-type operation, the surface of the disk or medium surface wears off due to the sliding contact if it has insufficient abrasion resistance or lubrication quality, resulting in breakage or damage if the medium wears off to a great extent, whereby operation of the disk drive for performing reading and reproducing operations becomes impossible. The protective overcoat layer is formed on the surface of the polycrystalline magnetic recording medium layer so as to protect the latter from friction and like effects due to the above-described sliding action of the magnetic head. A variety of abrasion-resistant, carbon (C)-containing protective overcoats have been developed and utilized for this purpose.

While many such carbon (C)-containing protective overcoats may be deposited by means of sputtering techniques, the results are not always satisfactory for a variety of reasons, including, inter alia, insufficient tribological performance and nodular deposition arising from arcing of the carbon sputtering target. An additional factor providing impetus for the development of non-sputtering techniques for depositing carbon-based protective overcoats arises from the continuous increase in areal recording density of magnetic recording media which, in turn, requires a commensurately lower flying height of the transducer head. Therefore, it is considered advantageous to reduce the thickness of the carbon-based protective overcoat layer (or multilayer) without incurring adverse consequences. Conventional sputtered a-C:H and a-C:N materials are difficult to uniformly deposit in defect-free manner, and generally do not function satisfactorily in hard disk applications at reduced thicknesses. Therefore, the use of alternative deposition techniques for developing thinner and harder DLC layers having the requisite mechanical and tribological properties has been examined, such as, for example, chemical vapor deposition (CVD), ion beam deposition (IBD), and cathodic arc deposition (CAD) techniques. Of these, the IBD method has demonstrated ability to be utilized for forming undoped and doped ion beam-deposited carbon films that exhibit superior tribological performance at reduced thicknesses.

Ion beam sources typically utilized for the deposition of IBD carbon-based films or coatings include circularly-configured wide beam sources, such as Kaufman, and gridless end-Hall and enclosed-drift end-Hall sources, e.g., as described in Handbook of Ion Beam Processing Technology, J. J. Cuomo et al., editors, Noyes Publications, Park Ridge, N.J., pp. 40-54. Such type ion beam sources typically operate at pressures below about 1 m Torr in order to minimize the collision of energetic ions forming the ion beam with ambient energy molecules of the background gas and enable formation of an intense, highly ionized plasma, thereby permitting diamond-like carbon (DLC) films to be obtained which exhibit optimum properties, e.g., hardness, for use as protective overcoat materials in hard disk applications.

Typically, such ion beam sources utilize a hot filament for generating energetic electrons which, in turn, create ionized fragments of the source gas (e.g., C₂H₂), and include at least an anode for electrostatically accelerating the ionized fragments toward a suitable deposition surface. The energy of the ion beam is largely determined by the anode voltage.

DLC materials in film or coating form can be produced on suitable hard disk substrates located in the path of the ion beam produced by such ion beam sources by introducing a monomeric hydrocarbon source gas (CₓH_{y}, where x=1-4 and y=2-10, e.g., acetylene (C₂H₂)) into the ion beam exiting the orifice of the source or by passing the source gas(es) through the ion beam source from the rear thereof. Film properties, e.g., carbon density, porosity, and surface roughness, are dependent upon the energy of the ion beam and therefore controllable/regulatable by appropriate selection of the anode-to-ground voltage and/or the bias voltage applied to the disk substrate during deposition thereon.

Thin film magnetic and MO media in disk form, such as described supra, are typically lubricated with a thin topcoat film or layer comprised of a polymeric lubricant, e.g., a perfluoropolyether, to reduce wear of the disc when utilized with data/information recording and read-out transducer heads operating at low flying heights, as in a hard disk system functioning in a CSS mode as described supra. Conventionally, the thin film of lubricant is applied to the disc surface(s) during manufacture by dipping into a bath containing a small amount of lubricant, e.g., less than about 1% by weight of a fluorine-containing polymer, dissolved in a suitable solvent, typically a perfluorocarbon, fluorohydrocarbon, or hydrofluoroether.

The lubricity properties of disk-shaped recording media are generally measured and characterized in terms of dynamic and/or static coefficients of friction. The former type, i.e., dynamic friction coefficient, is typically measured utilizing a standard drag test in which the drag produced by contact of a read/write transducer head with a disk surface is determined at a constant spin rate, e.g., 1 rpm. The latter type, i.e., static coefficients of friction (also known as “stiction” values), are typically measured utilizing a standard CSS test in which the peak level of friction is measured as the disk starts rotating from zero (0) rpm to a selected revolution rate, e.g., 5,000 rpm. After the peak friction has been measured, the disk is brought to rest, and the start/stop process is repeated for a selected number of start/stop cycles. An important property of a disk which is required for good long-term disk and drive performance is that the disk retain a relatively low coefficient of friction after many start/stop cycles or contacts with the read/write transducer head, e.g., 20,000 start/stop cycles.

The most commonly employed lubricants utilized with thin film, disk-shaped magnetic and MO media, i.e., perfluoropolyether (PFPE)-based lubricants, perform well under ambient conditions but not under conditions of higher temperature and high or low humidity. Studies have indicated that the tribological properties, and perhaps corrosion resistance, of perfluoropolyether-based lubricants utilized in the manufacture of thin film recording media can be substantially improved by addition thereto of an appropriate amount of a cyclotriphosphazene-based lubricant additive, e.g., a polyphenoxy cyclotriphosphazene comprising substituted or unsubstituted phenoxy groups, to form what is termed a “composite lubricant”. Currently, bis (4-fluorophenoxy)-tetrakis (3-trifluoromethyl phenoxy) cyclotriphospazene (available as X-1P™ from Dow Chemical Co., Midland, Mich.) is the additive most commonly utilized with perfluoropolyether-based lubricants for forming composite lubricants for use with thin film magnetic and MO media.

However, studies by the present inventors have determined that disk media with a protective overcoat/lubricant topcoat system comprised of a 30 Åthick IBD carbon protective overcoat layer deposited under substrate bias (hereinafter “bias IBD carbon”) and a Z-Dol/X-1P composite lubricant topcoat layer exhibit low certification yields (hereinafter “cert yield”), high “soft error counts” (i.e., intermittently weak signals or signal failures/errors arising from the lubricant topcoat not conforming well to the media surface), and poor performance when subjected to a drive accelerated environmental stress (hereinafter “AES”) read/write test at 80° C. and 90 R/H. Failure analysis of media which did not meet “cert” indicated the presence of lubricant on the cert heads. 50% of the media which failed the AES test exhibited head amplitude degradation; and failure analysis indicated touchdown marks either in the data zone or the landing zone of the disk. Failed heads had more debris accumulated at the trailing edge (“TE”) and cavity than was observed with heads which passed the AES test. No media corrosion product(s) was (were) observed.

It was also observed that the AES failure rate was substantially independent of the thickness of the bias IBD carbon protective overcoat layer thickness. Specifically, 2 out of 4 samples with a 32 Å thick bias IBD carbon protective overcoat layer failed, 3 out of 4 samples with a 35 Å thick bias IBD carbon protective overcoat layer failed, and 2 out of 4 samples with a 38 Å thick bias IBD carbon protective overcoat layer failed.

In view of the foregoing poor results associated with bias IBD carbon protective overcoat layers, there exists a clear need for an improved hard, abrasion and corrosion resistant protective overcoat layer or system for use with composite lubricant topcoat layers and which facilitates manufacture of magnetic and/or MO hard disk recording media exhibiting substantially improved performance with regard to the above-described test/evaluation criteria, and methodology therefor, which methodology is simple, cost-effective, and fully compatible with the productivity and throughput requirements of automated manufacturing technology.

The present invention fully addresses and solves the above-described problems attendant upon the formation and use of high areal recording density disk-type magnetic recording media comprising high performance protective overcoat/lubricant topcoat systems utilizing ultra-thin IBD carbon layers, while maintaining full compatibility with all mechanical and electrical aspects of conventional disk drive technology. In addition, the present invention enjoys utility in the formation of high performance protective overcoat/lubricant topcoat systems comprising ultra-thin IBD carbon layers required in the manufacture and use of thin film-based, ultra-high recording density magneto-optical (MO) data/information storage and retrieval media in disk form and utilizing conventional Winchester disk drive technology with laser/optical-based read/write transducers/heads operating at flying heights on the order of a few micro-inches above the media surface.

### DISCLOSURE OF THE INVENTION

An advantage of the present invention is an improved method of forming a dual-layer protective overcoat system on a surface of a workpiece, the dual-layer protective overcoat system being abrasion and corrosion resistant and bondable to a lubricant topcoat.

Another advantage of the present invention is an improved method of forming a dual-layer protective overcoat system on a surface of a recording medium, the dual-layer protective overcoat system being abrasion and corrosion resistant and bondable to a lubricant topcoat.

Yet another advantage of the present invention is improved recording media comprising a dual-layer protective overcoat system, the dual-layer protective overcoat system being abrasion and corrosion resistant and bondable to a lubricant topcoat.

Additional advantages and other features of the present invention will be set forth in the description which follows and in part will become apparent to those having ordinary skill in the art upon examination of the following or may be learned from the practice of the present invention. The advantages of the present invention may be realized and obtained as particularly pointed out in the appended claims.

According to one aspect of the present invention, the foregoing and other advantages are obtained by a method of forming a dual-layer protective overcoat system on a surface of a workpiece, the dual-layer protective overcoat system being abrasion and corrosion resistant and bondable to a lubricant topcoat, comprising sequential steps of:

(a) providing a workpiece including a surface;

(b) forming a first, bulk layer of a carbon (C) and hydrogen (H)-containing material on the surface of the workpiece, the bulk layer having a rough and porous upper surface; and

(c) forming a second, flash layer of a carbon (C) and nitrogen (N)-containing material on the surface of the bulk layer.

According to embodiments of the present invention, step (b) comprises forming the bulk layer of a C:H material; and step (c) comprises forming the flash layer of an a-C:N material; wherein step (b) comprises forming the bulk layer in a thickness from about 20 to about 40 Å; and step (c) comprises forming the flash layer in a thickness from about 2 to about 10 Å.

Preferred embodiments of the present invention include those wherein step (b) comprises forming the bulk layer in a thickness of about 30 Å; and step (c) comprises forming the flash layer in a thickness of about 5 Å; and wherein step (b) comprises forming the bulk layer by means of a non-biased ion beam deposition (IBD) process wherein the workpiece is unbiased during the IBD deposition process.

Alternative embodiments of the present invention are those wherein step (b) comprises regulating the energy of the ion beam such that a first, relatively thin portion of the bulk layer is deposited at a relatively low energy to avoid damage to the workpiece, a second, relatively thick portion of the bulk layer is deposited at a relatively high energy to have a relatively high carbon (C) density, and a third, relatively thin portion is deposited at a relatively low energy to form the rough and porous upper surface; and those wherein step (b) comprises utilizing an ion beam source wherein the energy of the ion beam is regulatable between relatively low and relatively high energies, and the bulk layer is deposited at the relatively low ion beam energy.

According to preferred embodiments of the present invention, step (b) comprises supplying an ion beam source with a hydrocarbon source gas of formula CₓH_{y}, where x=1-4 and y=2-10, e.g., acetylene (C₂H₂) gas; step (c) comprises forming the flash layer by means of a sputtering process, e.g., by sputtering a carbon (C) target in a nitrogen (N)-containing atmosphere.

Additional embodiments of the present invention comprise a further step of:

(d) applying a lubricant topcoat on a top surface of the flash layer.

In accordance with embodiments of the present invention, step (d) comprises applying a layer of a polymeric lubricant material; and preferred embodiments of the present invention include those wherein step (a) comprises providing as the workpiece a magnetic or magneto-optical recording medium comprising a laminate of layers formed on at least one surface of a substrate, and step (d) comprises applying a layer of a perfluoropolyether-based lubricant material, e.g., a layer of a composite lubricant material including a perfluoropolyether-based lubricant and an additive.

Another aspect of the present invention is a recording medium comprising:

(a) a substrate with a laminate of layers formed on at least one surface thereof, the laminate including at least one recording layer; and

(b) a dual-layer protective overcoat system on an outermost surface of the laminate, comprising:

(1) a first, bulk layer of a carbon (C) and hydrogen (H)-containing material on the outermost surface of the laminate, the bulk layer having a rough and porous upper surface; and

(2) a second, flash layer of a carbon (C) and nitrogen (N)-containing material on the upper surface of the bulk layer.

According to embodiments of the present invention, the bulk layer is comprised of a layer of a C:H material having a thickness from about 20 to about 40 Å; and the flash layer is comprised of a layer of an a-C:N material having a thickness from about 2 to about 10 Å.

Preferred embodiments of the present invention include those wherein the bulk layer is comprised of a layer of a C:H material having a thickness of about 30 Å; and the flash layer is comprised of a layer of an a-C:N material having a thickness of about 5 Å.

Further embodiments of the present invention include those comprising:

(c) a lubricant topcoat layer on a top surface of the flash layer.

Preferred embodiments of the present invention are those wherein the at least one recording layer is a magnetic recording layer and the recording medium is a magnetic recording medium or the at least one recording layer is a thermo-magnetic recording layer and the recording medium is a magneto-optical (MO) recording medium; and the lubricant topcoat layer is comprised of composite lubricant material including a primary lubricant material and at least one lubricant additive, e.g., the composite lubricant material comprises a perfluoropolyether primary lubricant material and at least one cyclotriphosphazene-based lubricant additive.

Additional advantages and aspects of the present invention will become readily apparent to those skilled in the art from the following detailed description, wherein embodiments of the present invention are shown and described, simply by way of illustration of the best mode contemplated for practicing the present invention. As will be describe, the present invention is capable of other and different embodiments, and its several details are susceptible of modification in various obvious respects. Accordingly, the drawings and description are to be regarded as illustrative in nature, and not as limitative.

### BRIEF DESCRIPTION OF THE DRAWING

The following detailed description of the embodiments of the present invention can best be understood when read in conjunction with the following drawing, in which the pertinent features are not necessarily drawn to scale but rather drawn as to best illustrate the pertinent features, wherein:

FIG. 1 illustrates, in simplified, schematic cross-sectional view, a portion of a magnetic recording medium including a dual-layer protective overcoat system according to the present invention.

### DESCRIPTION OF THE INVENTION

The present invention addresses and solves problems attendant upon the formation of ultra-thin, abrasion and corrosion-resistant protective overcoat layers suitable for use with high areal density magnetic recording media, such as are employed in hard drive applications, while maintaining full compatibility with all mechanical and electrical aspects of conventional disk drive technology. In addition, the present invention enjoys utility in the formation of ultra-thin, abrasion and corrosion-resistant protective overcoat layers required in the manufacture and use of thin film-based, ultra-high recording density magneto-optical (MO) data/information storage and retrieval media in disk form and utilizing conventional Winchester disk drive technology with laser/optical-based read/write transducers operating at flying heights on the order of a few micro-inches above the media surface.

Specifically, the present invention is based upon recognition that novel dual-layer protective overcoat systems which are hard, abrasion and corrosion-resistant, and provide enhanced bonding thereto of polymeric lubricant materials, may formed by depositing on a workpiece surface, e.g., a magnetic or magneto-optical (MO) recording medium, a first, bulk (i.e., relatively thick) DLC-type carbon (C) and hydrogen (H)-containing layer, e.g., C:H, having a rough and porous upper (or outer) surface, and then depositing thereon a second, flash (i.e., ultra-thin) carbon (C) and nitrogen (N)-containing layer, e.g., a-C:N. The novel dual-layer protective overcoat layer systems according to the invention are particularly well-suited for use as ultra-thin, protective overcoat layers of thin film magnetic and MO recording media, and exhibit superior properties, such as lubricant bonding/retention, vis-à-vis other types of dual-layer protective overcoat layer systems. Moreover, the inventive dual-layer protective overcoat layer systems are advantageously rapidly, conveniently, and cost-effectively fabricated by conventional techniques.

According to key features of the inventive methodology, the first, bulk (i.e., relatively thick) DLC-type carbon (C) and hydrogen (H)-containing layer, e.g., C:H, having a rough and porous upper (or outer) surface (characterized by low carbon (C)-atom densities of about 1.7-1.8 gms/cm³, vis-à-vis C:H layers with smooth and non-porous upper surfaces characterized by high carbon (C)-atom densities greater than about 2 gms/cm³, e.g., ˜2.2 gms/cm³) is formed by means of a non-biased ion beam deposition (IBD) process, wherein the workpiece (e.g., recording medium) is unbiased during the IBD process; and the second, flash (i.e., ultra-thin) carbon (C) and nitrogen (N)-containing layer, e.g., a-C:N, is deposited thereon by a sputtering process, e.g., by sputtering of a carbon (C) target in a nitrogen (N)-containing atmosphere.

The present invention has been made on the basis of the following requirements/functions of protective overcoat layers utilized with magnetic and magneto-optical (MO) recording media:

(1) Corrosion Protection. For adequate protection against corrosion, the protective overcoat must be sufficiently dense as to substantially prevent water or other corrosive agents from contacting, and thereby reacting with, the underlying magnetic or thermo-magnetic layer(s) of the media. Any reaction of the magnetic or thermo-magnetic layer(s) will result in loss of electrical signal, i.e., loss of data storage bits. Therefore, the overcoat should be hydrophobic in nature so that water or other polar corrosive agent(s) are unable to contact the magnetic or thermo-magnetic layer(s). In addition, the protective overcoat must have good resistance against electrochemically-induced corrosion.

(2) Durability. In order for the protective overcoat to be durable, it must be elastic as opposed to brittle. Elasticity advantageously allows the protective overcoat to survive occasional impacts between the disk and associated transducer (read/write) head(s).

(3) Flyability. Flyability requirements of the transducer (read/write) head necessitate that the lubricant topcoat layer conforms well to the protective overcoat surface without interference with the flying head. Good conformity of the lubricant topcoat layer to the protective overcoat layer under high speed flying conditions, as well as in hot, humid environments, requires from a mechanical standpoint, that the surface of the protective overcoat layer be rough and porous to increase affinity of the lubricant, thus facilitating good bonding, hence lubricant retention; and from a chemical standpoint, that the protective overcoat comprise chemical elements, bonds, etc., that promote good bonding of the lubricant molecules thereto.

The present invention is the result of a number of stepwise experiments conducted by the inventors in order to determine the proper combination of film composition and deposition technique for providing protective overcoat layers free of the aforementioned cert and AES test problems.

Specifically, since it is known that a-C:N layers promote enhanced bonding between carbon (C)-based protective overcoat layers and perfluoropolyether-based lubricant topcoat layers, deposition of an about 5 Å thick flash layer of sputtered a-C:N over a dense, smooth, bias-deposited C:H IBD film would a priori be expected to provide improved cert and AES test performance. In practice, however, 3 out of 5 samples failed the AES test.

The carbon (C) density of non-biased IBD C:H films (i.e., where the substrate/workpiece is unbiased during the IBD process) is ˜1.7 gm/cm³, whereas the carbon (C) density of biased C:H films formed at substrate/workpiece bias voltages of about −120 V (anode voltage 60 V) is substantially greater at ˜2.2 gm/cm³. The surfaces of the high carbon (C)-atom density C:H films formed by biased IBD are smoother than the rough and porous surfaces of the low carbon (C)-density non-bias IBD C:H films, presumably because the higher energy, more mobile species generated during the biased IBD process tend to fill the valleys and other depressions in the surface of the growing film. As a consequence, formation of C:H layers with rough and porous surfaces, as by non-biased IBD, capable of affording better lubricant bonding/retention would a priori be expected to provide improved cert and AES test performance. In practice, however 3 out of 5 samples with a non-biased IBD C:H protective overcoat layer (i.e., alone, without a flash a-C:N layer) failed the AES test.

Continuing with the above premise that the protective overcoat layer requires a rough and porous surface (as reflected in lower carbon (C)-atom densities of about 1.7-1.8 gms/cm³) to assist in bonding/anchoring and conforming the lubricant topcoat layer to the surface of the protective overcoat layer, it would a priori be expected that the presence of an implanted nitrogen (N)-rich region at the upper (top) surface portion of the protective overcoat layer would provide improved cert and AES results. In this regard, TOF-SIMS measurements were performed to confirm that the N/C atom ratios of the samples with N-implanted, non-biased IBD C:H were similar to the N/C atom ratios of sputtered a-C:N films. In practice, however, it was determined that the samples with the N-implanted, non-biased IBD C:H films still exhibited low cert yields and high AES failure rates.

While not desirous of being bound by any particular theory, it is nonetheless considered that the above-described behavior is attributable to the presence of hydrogen (H) atoms in the IBD C:H protective overcoat layers, arising from the use of a hydrocarbon source gas CₓH_{y}, which hydrogen (H) atoms are bonded to carbon (C) atoms on the surface of the protective overcoat layer. The nitrogen (N) implantation process is unable to remove (strip) all of the hydrogen (H) atoms from the carbon (C) atoms on the surface, and the remaining hydrogen (H) atoms tend to substantially weaken the surface interactions with the lubricant topcoat material even when a substantial amount of implanted nitrogen (N) atoms are present on or proximate the surface.

Another factor affecting the interactions between the carbon (C)-based protective overcoat layer(s) and the lubricant topcoat layer is the nature of the specific lubricant system. As indicated supra, current “composite lubricant” systems typically comprise a primary polymeric perfluoropolyether-based lubricant, e.g., Z-Dol, together with a cyclotriphosphazene-based lubricant additive, e.g., X-1P, to help provide an adequate durability margin. However, the addition of X-1P to Z-Dol affects bonding of the Z-Dol to the carbon-containing surface of the protective overcoat layer. As a consequence of the aforementioned, it is considered that a proper surface topography, i.e., roughness and porosity, of the bulk protective overcoat layer and an a-C:N flash layer formed by sputtering of a carbon target in a pure nitrogen atmosphere, are essential for providing optimal accommodation of the Z-Dol/X-1P composite lubricant system. The fact that similar issues do not arise with bias IBD carbon protective layers and perfluoropolyether-based lubricants supports this hypothesis. It is also understandable that UV treatment of Z-Dol/X-1P composite lubricant topcoat films formed on carbon (C)-based protective overcoat layers increases lubricant retention, because UV irradiation promotes bonding between lubricant molecules and between the lubricant molecules and the carbon (C)-containing surface of the protective overcoat layer.

However, lubricated disks that pass the cert test routinely fail the AES test conducted under conditions of high humidity and temperature, which conditions are known to degrade/weaken bonding between the lubricant molecules and the carbon (C)-containing protective overcoat layer, leading to lubricant transfer to the transducer head(s).

According to the invention, issues relating to low cert yields, high soft error counts, and AES failure rates essentially disappear when dual-layer protective overcoat system is formed by depositing, as by non-biased IBD, a first, bulk (i.e., relatively thick) DLC-type carbon (C) and hydrogen (H)-containing layer, e.g., C:H, having a rough and porous surface on the surface of the uppermost layer of the magnetic or MO recording medium, and then depositing thereon, as by sputtering a carbon target in a pure nitrogen atmosphere, a second, flash (i.e., ultra-thin) carbon (C) and nitrogen (N)-containing layer, e.g., a-C:N.

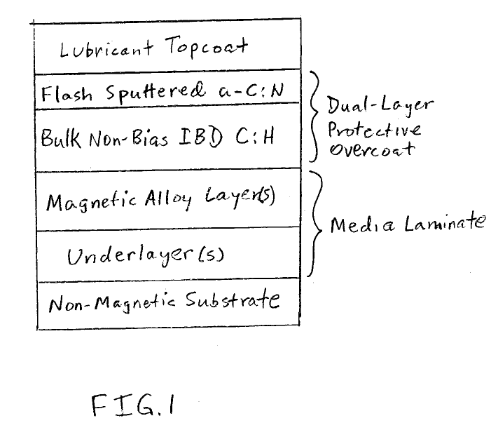

Referring to FIG. 1, illustrated therein, in simplified, schematic cross-sectional view, is a portion of a magnetic recording medium including a dual-layer protective overcoat system according to the present invention. As illustrated, the magnetic medium comprises a non-magnetic substrate with a conventional laminate of layers formed thereon, including one or more underlayers, e.g., a polycrystalline Cr or Cr-based alloy layer, and one or more polycrystalline magnetic alloy layers, e.g., a cobalt (Co)-based alloy. Overlying the uppermost magnetic alloy layer is the inventive dual-layer protective overcoat system, comprised of a first, bulk layer of a carbon (C)-containing and hydrogen (H)-containing material on the surface of the workpiece, the bulk layer having a rough and porous upper surface; and a second, flash (i.e., ultra-thin) layer of a carbon (C) and nitrogen (N)-containing material on the surface of the bulk layer.

According to embodiments of the present invention, the first, bulk layer is formed of a non-biased ion-beam deposited (IBD) C:H material (i.e., wherein the substrate/workpiece is not electrically biased during the IBD), having a thickness from about 20 to about 40 Å, preferably about 30 Å; and the second flash layer is an a-C:N material formed by sputtering of a carbon (C) target in a nitrogen (N₂)-containing atmosphere, having a thickness from about 2 to about 10 Å, preferably about 5 Å.

As has been indicated supra, a key feature of the non-biased IBD process is the formation of C:H films with a rough and porous surfaces, as reflected by lower carbon (C)-atom densities of about 1.7-1.8 gms/cm³ vis-à-vis the higher carbon (C)-atom densities of about˜2.2 gms/cm³ of the smooth-surfaced C:H films provided by biased IBD. The rough and porous surfaces of the non-biased IBD C:H films afford increased lubricant affinity, thereby enabling enhanced lubricant penetration, conformity and bonding thereto, vis-à-vis the smooth-surfaced, higher carbon (C)-atom density films formed by biased IBD.

Embodiments of the present invention include those wherein the energy of the ion beam utilized for the non-biased IBD is regulated such that a first, relatively thin portion of the bulk C:H layer is deposited at a lower energy to avoid damage to the workpiece/substrate, e.g., the magnetic alloy layer, a second, relatively thick portion of the bulk C:H layer is then deposited at a higher energy to have a relatively high carbon (C) density of about 2.0 C gms/cm³, and a third, relatively thin portion of the bulk C:H layer having a relatively low carbon (C) density of about 1.7-1.8 C gms/cm³ is finally deposited at a lower energy to form the desired rough and porous upper surface.

According to other embodiments of the invention, the energy of the ion beam utilized for the non-biased IBD of the first, bulk C:H layer of the dual-layer protective overcoat system is regulatable between relatively low (i.e., about 60 eV) and relatively higher energies (i.e., greater than bout 60 eV), and the entire thickness of the bulk C:H layer is deposited at the relatively low ion beam energy.

According to preferred embodiments of the present invention, the ion beam source is supplied with a (monomeric) hydrocarbon source gas of formula CₓH_{y} where x=1-4 and y=2-10, e.g., acetylene (C₂H₂) gas; and the flash layer is preferably formed by sputtering a carbon (C) target in a pure nitrogen (N₂) atmosphere. The non-biased IBD C:H films formed according to the invention are hydrophobic by virtue of the presence of the hydrogen (H) atoms therein; and film resistance is regulatable by selecting the H/C ratio of the CₓH_{y} source gas.

Referring still to FIG. 1, the medium according to the invention further includes a polymer-based lubricant topcoat layer from about 14 to about 18 Å thick, preferably about 16 Å thick, formed (in conventional manner, e.g., as by dipping or spraying) on the C:N flash layer of the dual-layer protective overcoat system. According to preferred embodiments of the present invention, the lubricant topcoat layer comprises a perfluoropolyether-based lubricant material, e.g., a layer of a composite lubricant material comprised of perfluoropolyether-based lubricant, such as Z-Dol and a cyclotriphosphazene lubricant additive, such as X-1P.

Media comprising the inventive non-biased IBD C:H bulk layer/sputtered C:N flash layer dual-layer protective overcoat system and Z-Dol/X-1P composite lubricant topcoat, such as illustrated in FIG. 1, exhibited a 100% pass rate when subjected to AES testing, clearly demonstrating a dramatic improvement in performance reliability afforded by the inventive methodology.

The present invention therefore provides a number of advantages over the conventional bias-deposited IBD C:H protective overcoat layers and nitrogen-implanted and a-C:N flash layer systems based thereon, currently available for use as abrasion and corrosion-resistant protective overcoat layers for magnetic and MO recording media, such as hard disks. More specifically, the dual-layer protective overcoat systems of the present invention, comprised of a first, bulk layer of a non-bias deposited IBD hydrogenated carbon (C:H) and a second, sputtered a-C:N flash layer provide enhanced lubricant retention and reduced corrosion, leading to improved CSS operation with 100% cert and AES pass rates at ultra-thin thicknesses (i.e., ˜30 Å), and thus are eminently suitable for use in the manufacture of very high areal recording density magnetic and MO media and devices therefor requiring operation of read/write transducers at extremely low flying heights. In addition, the inventive means and methodology are fully compatible with all other aspects of automated manufacture of magnetic and MO media and are useful in a variety of other industrially significant applications, including, but not limited to, formation of hard, abrasion and corrosion resistant coatings useful in the manufacture of tools, bearings, turbines, etc.

In the previous description, numerous specific details are set forth, such as specific materials, structures, reactants, processes, etc., in order to provide a better understanding of the present invention. However, the present invention can be practiced without resorting to the details specifically set forth. In other instances, well-known processing materials and techniques have not been described in detail in order not to unnecessarily obscure the present invention.

What is claimed is:

1. A method of forming a dual-layer protective overcoat system on a surface of a workpiece, said dual-layer protective overcoat system being abrasion and corrosion resistant and bondable to a lubricant topcoat, comprising sequential steps of:
(a) providing a workpiece including a surface;
(b) forming a first, bulk layer of a carbon (C) and hydrogen (H)-containing material on said surface of said workpiece, said bulk layer having a rough and porous upper surface; and
(c) forming a second, flash layer of a carbon (C) and nitrogen (N)-containing material on said surface of said bulk layer.

2. The method according to claim 1, wherein:
step (b) comprises forming said bulk layer of a C:H material; and
step (c) comprises forming said flash layer of an a-C:N material.

3. The method according to claim 2, wherein:
step (b) comprises forming said bulk layer in a thickness from about 20 to about 40 Å; and
step (c) comprises forming said flash layer in a thickness from about 2 to about 10 Å.

4. The method according to claim 3, wherein:
step (b) comprises forming said bulk layer in a thickness of about 30 Å; and
step (c) comprises forming said flash layer in a thickness of about 5 Å.

5. The method according to claim 2, wherein:
step (b) comprises forming said bulk layer by means of a non-biased ion beam deposition (IBD) process wherein said workpiece is unbiased during said IBD deposition process.

6. The method according to claim 5, wherein:
step (b) comprises regulating the energy of the ion beam such that a first, relatively thin portion of said bulk layer is deposited at a relatively low energy to avoid damage to said workpiece, a second, relatively thick portion of said bulk layer is deposited at a relatively high energy to have a relatively high carbon (C) density, and a third, relatively thin portion is deposited at a relatively low energy to form said rough and porous upper surface.

7. The method according to claim 5, wherein:
step (b) comprises utilizing an ion beam source wherein the energy of said ion beam is regulatable between relatively low and relatively high energies, and said bulk layer is deposited at said relatively low ion beam energy.

8. The method according to claim 5, wherein:
step (b) comprises supplying an ion beam source with a hydrocarbon source gas of formula CₓH_{y}, where x=1-4 and y=2-10.

9. The method according to claim 8, wherein:
step (b) comprises supplying said ion beam source with acetylene (C₂H₂) gas.

10. The method according to claim 2, wherein:
step (c) comprises forming said flash layer by means of a sputtering process.

11. The method according to claim 10, wherein:
step (c) comprises sputtering a carbon (C) target in a nitrogen (N)-containing atmosphere.

12. The method according to claim 1, further comprising a step of:
(d) applying a lubricant topcoat on a top surface of said flash layer.

13. The method according to claim 12, wherein:
step (d) comprises applying a layer of a polymeric lubricant material.

14. The method according to claim 13, wherein:
step (d) comprises applying a layer of a perfluoropolyether-based lubricant material.

15. The method according to claim 13, wherein:
step (d) comprises applying a layer of a composite lubricant material including a perfluoropolyether-based lubricant and an additive.

16. The method according to claim 1, wherein:
step (a) comprises providing as said workpiece a magnetic or magneto-optical recording medium comprising a laminate of layers formed on at least one surface of a substrate.

17. A recording medium comprising:
(a) a substrate with a laminate of layers formed on at least one surface thereof, said laminate including at least one recording layer; and
(b) a dual-layer protective overcoat system on an outermost surface of said laminate, comprising:
(1) a first, bulk layer of a carbon (C) and hydrogen (H)-containing material on said outermost surface of said laminate, said bulk layer having a rough and porous upper surface; and
(2) a second, flash layer of a carbon (C) and nitrogen (N)-containing material on said upper surface of said bulk layer.

18. The medium as in claim 17, wherein:
said bulk layer is comprised of a layer of a C:H material having a thickness from about 20 to about 40 Å; and
said flash layer is comprised of a layer of an a-C:N material having a thickness from about 2 to about 10 Å.

19. The medium as in claim 18, wherein:
said bulk layer is comprised of a layer of a C:H material having a thickness of about 30 Å; and
said flash layer is comprised of a layer of an a-C:N material having a thickness of about 5 Å.

20. The medium as in claim 17, further comprising:
(c) a lubricant topcoat layer on a top surface of said flash layer.

21. The medium as in claim 20, wherein:
said lubricant topcoat layer is comprised of composite lubricant material including a primary lubricant material and at least one lubricant additive.

22. The medium as in claim 21, wherein:
said composite lubricant material comprises a perfluoropolyether primary lubricant material and at least one cyclotriphosphazene-based lubricant additive.

23. The medium as in claim 17, wherein:
said at least one recording layer is a magnetic recording layer and said recording medium is a magnetic recording medium.

24. The medium as in claim 17, wherein:
said at least one recording layer is a thermo-magnetic recording layer and said recording medium is a magneto-optical (MO) recording medium.
